(19) United States
(12) Patent Application Publication
(10) Pub. No.: US 2014/0188518 A1
(43) Pub. Date: Jul. 3, 2014

(54) Medical Screening System

(71) Applicant: Advance Health, Chantilly, VA (US)

(72) Inventor: Brian Wise, Chantilly, VA (US)

(73) Assignee: Advance Health, Chantilly, VA (US)

(21) Appl. No.: 14/144,453

(22) Filed: Dec. 30, 2013

Related U.S. Application Data
(60) Provisional application No. 61/908,354, filed on Nov. 25, 2013.
(60) Provisional application No. 61/747,186, filed on Dec. 28, 2012.

(51) Int. Cl. G06F 19/00

(52) U.S. Cl. CPC G06F 19/3431; G06F 19/328
USPC 705/3

(57) ABSTRACT

A medical screening system includes: a mobile device including: a user interface embodied in an input/output system; a processor; and a memory in communication with the processor, including stored instructions that, when executed by the processor, cause the processor to: provide a medical screening intake system that receives objective medical data, subjective medical data, and medical test results for a person as input through the user interface; receive the objective medical data, subjective medical data, and medical test results for the person as input through the user interface; automatically process the objective medical data, subjective medical data, and medical test results to generate one or more plans of care specifically adapted for the person; and communicate the one or more plans of care specifically adapted for the person to the person as a report embodied in a structured data output.

### BACKGROUND OF THE INVENTION

The present subject matter relates generally to a medical screening system embodied in a mobile application. More specifically, the present invention relates to a medical screening system adapted to collect objective and subjective information for providing a quantified evaluation of the health status of customers of health insurance plans and accountable care organizations. The present invention further uses the data collected to automatically provide one or more recommended plans of care.

Medical insurance providers use medical screenings to assess the health and medical history of potential customers. Typically, a representative of the medical insurance company administers tests to an individual at the individual's home or at another designated location. A typical medical screening includes: (1) questions related to the potential customer's medical history, family's medical history, health related habits (e.g., smoking, drinking, exercise, etc.) and mental health; and (2) physical tests (e.g., blood tests, blood pressure, and other physical examinations). The medical insurance provider then uses the data collected and the test results to determine what additional services the customer may or may not need to improve their health status based on the individual's risk profile.

Medical screening questionnaires are typically provided and completed in paper form, requiring the medical company representative to transport paperwork to the potential customer's house, where both the representative and the potential customer complete the paperwork together, and then be responsible for returning the paperwork to a data processor who inputs the data into a central system. The paperwork can be burdensome and may be difficult to keep organized. Paper data also presents a risk of loss and violation of the federal HIPAA laws and regulations.

In addition, because the medical data is collected manually, the data is not compiled and analyzed until well after the customer's portion of the medical screening is complete. As a result, it is difficult to provide helpful and relevant information to the potential customer at the time of the evaluation.

Moreover, while existing medical screening systems are commonly used by medical insurance providers during the assessment stage for new potential clients or when existing clients request additional coverage. There may be advantages to implementing screening systems for existing medical insurance customers.

Accordingly, there is a need for an electronic mobile medical screening system, as described and claimed herein.

### BRIEF SUMMARY OF THE INVENTION

The subject matter presented herein provides a medical screening system embodied in a software-based system. In a preferred embodiment, the medical screening system is provided as mobile application for use with mobile devices such as tablet computers. The medical screening system enables an active assessment of subjective and objective medical screening data collected from potential and existing customers. Based on the screening data collected, the system may automatically recommend a plan of care for the customer. All of the collected data may be automatically synced to a secure database, for example by sending the encrypted data to a secure FTP site. The system further provides a platform to score customers' objective and relative risk profiles. The customer's scored risk profiles may be used to automatically develop and provide one or more recommended plans of care.

The medical screening system may be utilized through a mobile device that securely communicates with an associated database. For example, the mobile device may be used to collect the data during a medical screening and then later, when connected to a wired or wireless communication network, the collected data may be securely uploaded to the database. Accordingly, the mobile device may function as a temporary storage device for the medical screening system until an appropriate time for the information to be synced to the database.

A user may access and interact with the elements of the medical screening system through a user interface provided through the mobile device, such as a tablet, smart phone, or any other mobile device with communication capabilities.

The following is an example describing how a medical screening may be completed using the medical screening system provided herein to collect the customer data. First, a user securely accesses the system through a mobile application embodied in a mobile device using a username and password. Next, the user selects the appropriate customer file into which the data will be stored. At any point in time, the application within the user's mobile device may include a number of customer files for which either: (1) data is to be collected; or (2) data has been collected, but not yet synched to the associated database. After the appropriate customer file is selected, the user follows the guidance of the system to collect medical information from the customer, including objective data regarding the customer's personal information, medical history, family medical history, physical examination data (e.g., blood pressure), etc. Because the user (i.e., medical technician) may conduct the information collection process in the customer's home, additional subject information may be collected, such as information concerning the living conditions and/or surroundings. For example, if the customer claims to be a non-smoker, but the house smells of smoke, the representative may make note of this observation. While with the customer, the user may collect samples from the customer for lab testing (e.g., blood sample, urine sample, etc.). The later acquired results of such tests may be incorporated into the data set collected by the user and saved in the associated database.

As the user goes through the data collection process, the collected data is saved within the application on the mobile device. The collected data may be temporarily saved on the mobile device. Then, once the mobile device is in communication with the associated database, for example through a wired or wireless communication network, the data may be synched with the associated database.

In one example, once the initial data is collected, the medical screening system automatically provides one or more recommended plans of care based on the data collected from the customer by the user. For example, as the customer's information is collected, the medical screening system may automatically access stored recommended plans of care. For example, if the data collected indicates the customer has elevated blood pressure, several recommended plans of care, e.g., standard recommendations from the Centers for Disease Control and Prevention (“CDC”), may automatically populate a report to be shared with the customer. The recommended plans of care may triggered by various data or data sets collected through the application. For example, some recommended plans of care might be based on the customer's age data, family history data, prior medical history, or other factors associated with the collected data.

An objective score may be assigned to the customer based on the data collected. The medical insurance company may use the objective score to assess the risk of future medical claims from any customer. Because the database stores the data from a plurality of customers, the data may be further used to assign a relative (or comparative) risk score for a provided class of customers. The two risk assessment scores may be used to assist the medical insurance provider in determining what services to offer customers to help improve their health and lower the likelihood of future medical claims. Moreover, the objective risk scores may be analyzed across groups of customers. For example, the collected data may be analyzed to provide a year-over-year comparative analysis of objective risk scores. This data can be analyzed and used to generate numerous and varied metrics beneficial to the management of insurance companies and/or accountable care organizations, as will be appreciated by those skilled in the art based on the descriptions provided herein.

The risk scores may be used by insurance companies and/or accountable care organizations to manage their customers by identifying those customers for whom additional care or counseling may be of greatest benefit. This enables the insurance companies and/or accountable care organizations to optimize the allocation of their resources to the customers for whom the resources are best used. Further, by implementing a medical screening system that automatically outputs recommended plans of care for each customer, the medical screening system automatically takes appropriate actions to improve the condition of each customer while identifying opportunities to optimize resources.

In a first example, a medical screening system includes: a mobile device including: a user interface embodied in an input/output system; a processor; and a memory in communication with the processor, including stored instructions that, when executed by the processor, cause the processor to: provide a medical screening intake system that receives objective medical data, subjective medical data, and medical test results for a person as input through the user interface; receive the objective medical data, subjective medical data, and medical test results for the person as input through the user interface; automatically process the objective medical data, subjective medical data, and medical test results to generate one or more plans of care specifically adapted for the person; and communicate the one or more plans of care specifically adapted for the person to the person as a report embodied in a structured data output.

The one or more plans of care may include standard recommendations from the Centers for Disease Control and Prevention for conditions identified in the objective medical data, subjective medical data, or medical test results.

The medical screening system may further include a server in communication with one or more of the mobile devices, wherein the server stores the objective medical data, subjective medical data, and medical test results for two or more people.

An objective score may be assigned for each person for whom objective medical data, subjective medical data, and medical test results is stored. The objective score may identify the individual person's risk of future medical claims.

A relative risk score may be assigned for each person for whom objective medical data, subjective medical data, and medical test results is stored. The relative risk score may quantify the relative risk of future medical claims for each person for whom objective medical data, subjective medical data, and medical test results is stored as compared to the other people for whom objective medical data, subjective medical data, and medical test results is stored.

The medical screening system may further automatically stratify the people for whom objective medical data, subjective medical data, and medical test results is stored into two or more risk classes, wherein the risk classes are distinguished by the relative risk of future medical claims for the people in each risk class.

In another example, a medical screening system includes: one or more mobile devices, each mobile device including: a user interface embodied in an input/output system; a processor; and a memory in communication with the processor, including stored instructions that, when executed by the processor, cause the processor to: provide a medical screening intake system that receives objective medical data, subjective medical data, and medical test results for a person as input through the user interface; receive the objective medical data, subjective medical data, and medical test results for the person as input through the user interface; and automatically process the objective medical data, subjective medical data, and medical test results to generate one or more plans of care specifically adapted for the person; and a server in communication with one or more of the mobile devices, wherein the server stores the objective medical data, subjective medical data, and medical test results for two or more people; wherein an objective score is assigned for each person for whom objective medical data, subjective medical data, and medical test results is stored, wherein the objective score identifies the individual person's risk of future medical claims; wherein a relative risk score is assigned for each person for whom objective medical data, subjective medical data, and medical test results is stored, wherein the relative risk score quantifies the relative risk of future medical claims for each person for whom objective medical data, subjective medical data, and medical test results is stored as compared to the other people for whom objective medical data, subjective medical data, and medical test results is stored; wherein the system automatically stratifies the people for whom objective medical data, subjective medical data, and medical test results is stored into two or more risk classes, wherein the risk classes are distinguished by the relative risk of future medical claims for the people in each risk class.

An advantage of the medical screening system is that it provides a semi-automated medical screening platform for use on mobile devices.

Another advantage of the medical screening system is that decreases the amount of paperwork and error typically associated with medical screenings.

A further advantage of the medical screening system is that it automatically provides a plan of care to the customer at the conclusion of the medical screening.

Another advantage of the medical screening system is that it automatically syncs the stored data when the mobile device is in communication with a central database.

Still another advantage of the medical screening system is that it provides objective and relative risk scores based on data collected from a plurality of customers.

Yet another advantage of the medical screening system is that it increases the efficiency of assessing customers and provides organization to the medical insurance provider.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a block diagram of a medical screening system including a mobile device used by a first user, in communication with a server, and another device used by a second user to access the server.

FIG. 2 is a flow chart illustrating a method of collecting information including: collecting objective information, subjective information, and test results; generating one or more recommended plans of care; and generating objective and relative risk scores.

FIG. 3 is an example of an interface through which a user may access a medical screening system using a username and password.

FIG. 4 is an example of an interface through which a user may select an application for data collection.

FIG. 5 is an example of an interface through which a user may input a customer's demographic and personal information.

FIG. 6 is an example of an interface through which a user may input data related to a customer's current living arrangements.

FIG. 7 is an example of an interface through which a user may input data related to a customer's family history.

FIG. 8 is an example of an interface through which a user may input data related to a customer's medical conditions.

FIG. 9 is an example of an interface through which a user may access the recommended plans of care.

FIG. 10 is an example of an interface through which a user may view pending and completed applications and sync any completed application data.

FIG. 11 is a flow chart illustrating a method executed by a medical screening system to generate one or more plans of care specifically adapted for the customers and to communicate the one or more plans of care to the customers as a report embodied in a structured data output.

FIG. 12 is a flow chart illustrating a method executed by a medical screening system to automatically stratify the people for whom objective medical data, subjective medical data, and medical test results is stored into two or more risk classes, wherein the risk classes are distinguished by the relative risk of future medical claims for the people in each risk class.

### DETAILED DESCRIPTION OF THE INVENTION

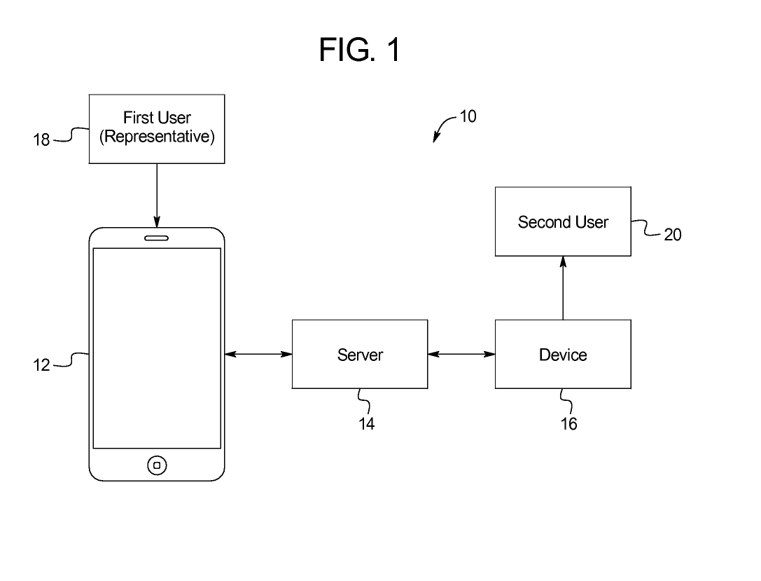

FIG. 1 illustrates an example of a system 10 in which the present subject matter may be embodied (referred to herein as the “medical screening system 10”). In the example shown in FIG. 1, the medical screening system 10 includes a mobile device 12 associated with a server 14. In addition, the medical screening system 10 is shown incorporating another device 16 in communication with the server 14. The purpose of the server 14 is to facilitate the flow and storage of information within the medical screening system 10. Though the mobile device 12 may also function as a temporary storage means for the medical screening system 10 until the information is synced to the server 14, as described further herein.

In the example shown in FIG. 1, a first user 18 may access and interact with the elements of the medical screening system 10 through the mobile device 12. The mobile device 12 may be any portable electronic device, such as a tablet, smart phone, or any other mobile communication device. The mobile device 12 includes a user interface for inputting data, such as a touch screen, keyboard, microphone, camera, or any other device used for data collection. As further shown, a second user 20 may access and interact with data stored on the server 14 through another device 16. The other device may be any electronic device in communication with the server, whether portable or not. Accordingly, while a first user 18 collects data through the mobile device 12 and stores the data on the server 14, a second user 20 may access and interact with the data through a second device 16 as discussed in greater detail herein.

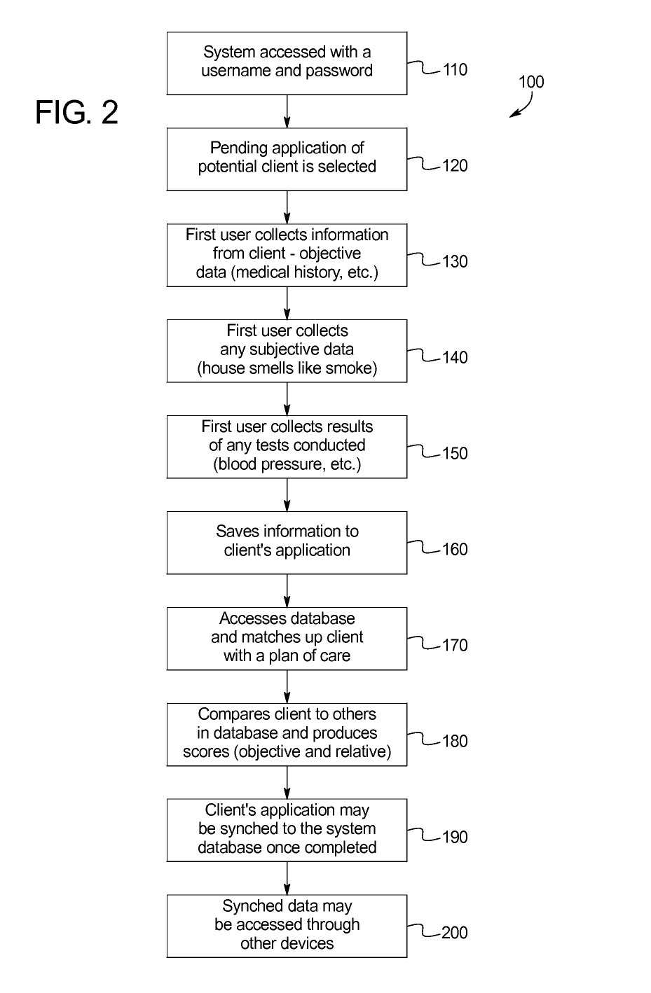

Turning now to FIG. 2, an example of a method 100 of collecting medical screening information through the medical screening system 10 is shown. As shown in FIG. 2, in the first step 110, a user accesses an application resident on the mobile device 12 using a username and password. In the example used, the mobile device 12 is a tablet computer including a touch screen input mechanism. However, it is contemplated that the mobile device 12 may be any of numerous forms and the description provided herein is merely one example based on such a mobile device 12.

Once logged into the system, the first user 18 may collect information for the medical screening system 10. There may be more than one customer application from which to choose within the application resident on the mobile device 12. Accordingly, in the second step 120, the user selects a pending application for which data is to be collected.

In the third step 130, the first user 18 collects objective information from the customer. This data may include personal information, medical history, family medical history, etc.

In the fourth step 140 in FIG. 2, the first user 18 collects subjective information from the customer. This information may include what the representative observes regarding the customer, the customer's house, surroundings, etc. For example, if the customer claims to be a non-smoker, but the customer's house smells of smoke, the representative may make note of this observation.

In the fifth step 150, the first user 18 collects the results of any test conducted. These tests may include blood tests, blood pressure, or any other medical testing such as a physical examination.

During the sixth step 160 (which may occur continuously in real-time or at a specified time in the process), the application saves the information collected to the mobile device 12. In some examples, the information may be temporarily saved on the mobile device 12 and then uploaded to the server 14 once the mobile device 12 is in communication with the server 14, as described further herein.

In the seventh step 170, the medical screening system 10 uses the data collected in the previous steps to provide a recommended a plan of care. The recommended plan of care is based on the information collected by the first user 18. Once the information is saved, the medical screening system 10 may instantaneously access the database and provide a plan of care for the customer.

In the eighth step 180, the medical screening system 10 uses the data collected by the first user 18 to objectively score the customer for evaluation of the risk of initiating or continuing to insure the customer. The medical screening system 10 may further determine a relative ranking for the data to compare the customer to other customers in the database. Such relative rankings may provide a better context for the insurer in determining which potential customers to insure and at which rates and also how to most optimally direct resources to improve the health of current customers.

After the customer's application is complete, in the ninth step 190, the customer's application may be synced to the server 14. Once synced to the server 14, the information may be available by another device 16. For example, in certain embodiments, it is contemplated that the mobile device 12 may communicate with the server 14 over wireless networks. In such instances, the wireless networks may not always been accessible. Accordingly, when the mobile device 12 enters into a location in which the communication network is available and the mobile device 12 and server 14 may communicate freely, the data stored on the mobile device 12 may be uploaded to the server 12.

In the tenth and final step 200, after the collected data is synced to the server 14, the other device 16 (or other devices 16) may access the data, for example, for the purposes described in the examples provided herein.

While generally described above, some of the steps in the process are further illustrated using screenshots of an example of an application resident on a mobile device 12 embodying the solutions taught herein.

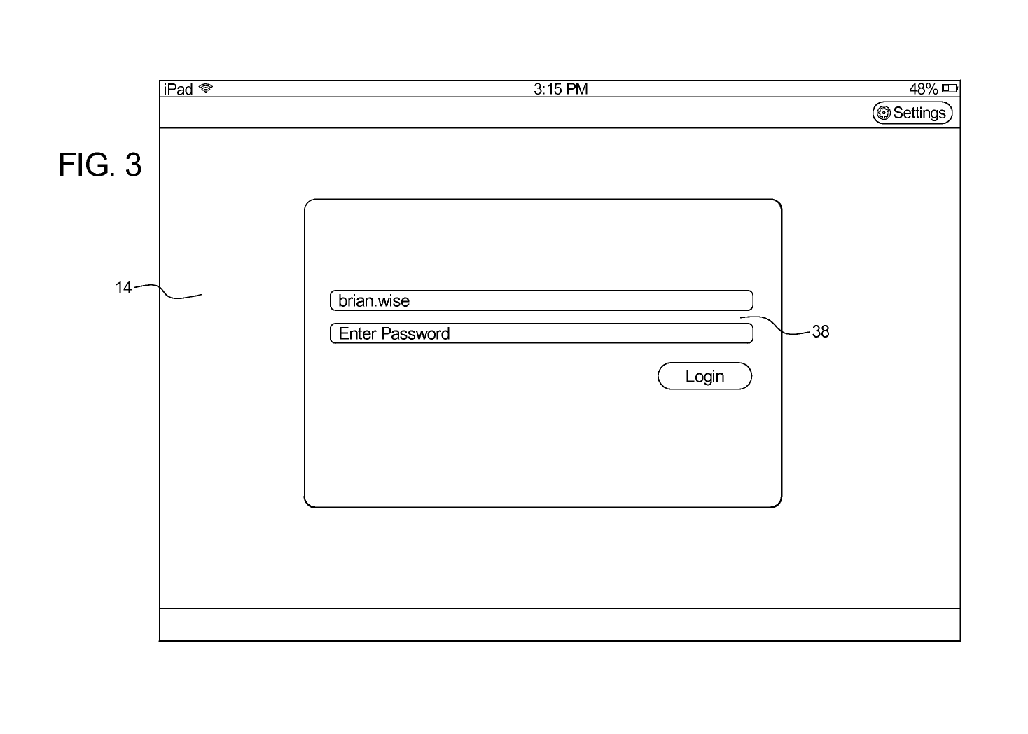

Turning now to FIG. 3, in the example provided, the first screen of the application embodying the medical screening system 10 is a login screen 30. As typical, the login screen 30 may include entry fields 38 into which a user 18 may enter the appropriate access credentials to access the application embodying the medical screening system 10. In the example shown in FIG. 3, access credentials includes a username and password. However, it is understood that in other embodiments the access credentials may include a greater or lesser amount of information or that the login process may be accomplished any other form. After the user 18 enters the appropriate information, the user 18 may access the medical screening system 10.

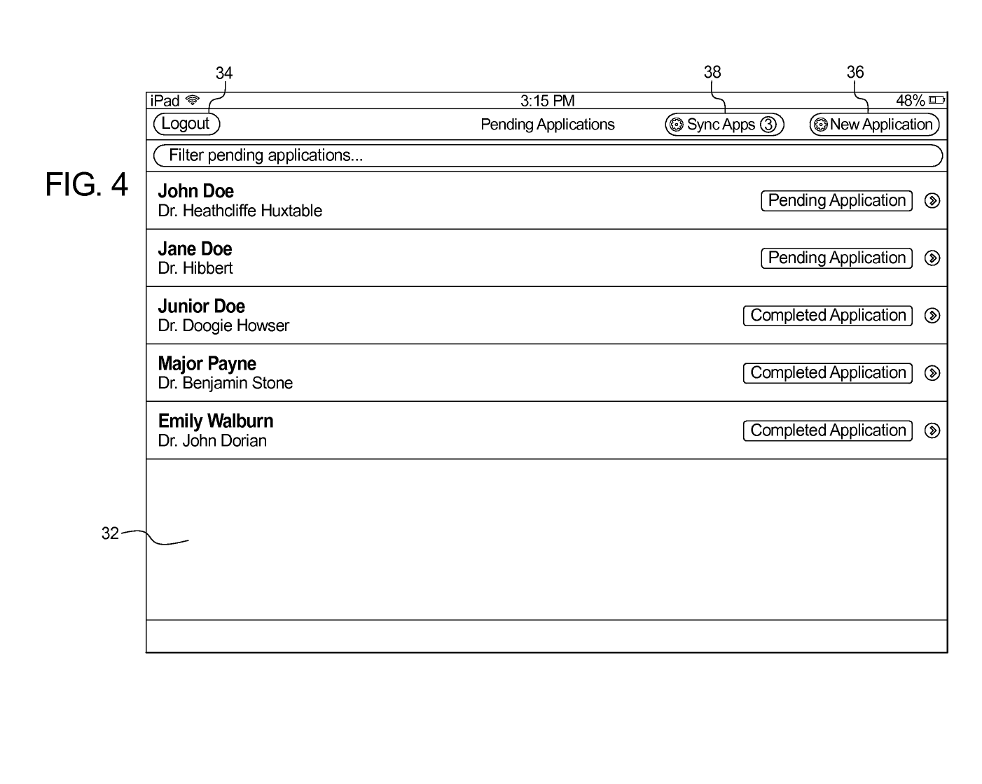

FIG. 4 illustrates an application selection screen 32 the user 18 may access after login. The application selection screen 32 includes a list of applications for customers. In the example shown in FIG. 4, each application is either marked as having a pending application or a completed application. The example shown in FIG. 4, labels each application with the name of the customer and their doctor. However, it is contemplated that in other embodiments the applications may be distinguished in any other way. For example, the application selection screen 32 may not include the name of the doctor and may only include the names of the customers. The application selection screen 32 may also include an exit button 34 for the user to logout, an addition button 36 for adding a new application, and a sync button 38 for syncing the data to the server 14.

In the example shown in FIG. 4, the sync button 38 is shown with a green number three, representing that there are three completed applications listed on the applications screen 32. Once the sync button 38 is selected, the completed applications may be synced to the server 14 and removed the application selection screen 32 and the memory in the mobile device 12. However, in other examples, it is contemplated that the synced applications may remain on the mobile device 12 (and the application selection screen 32) even after they are synced to the server 14.

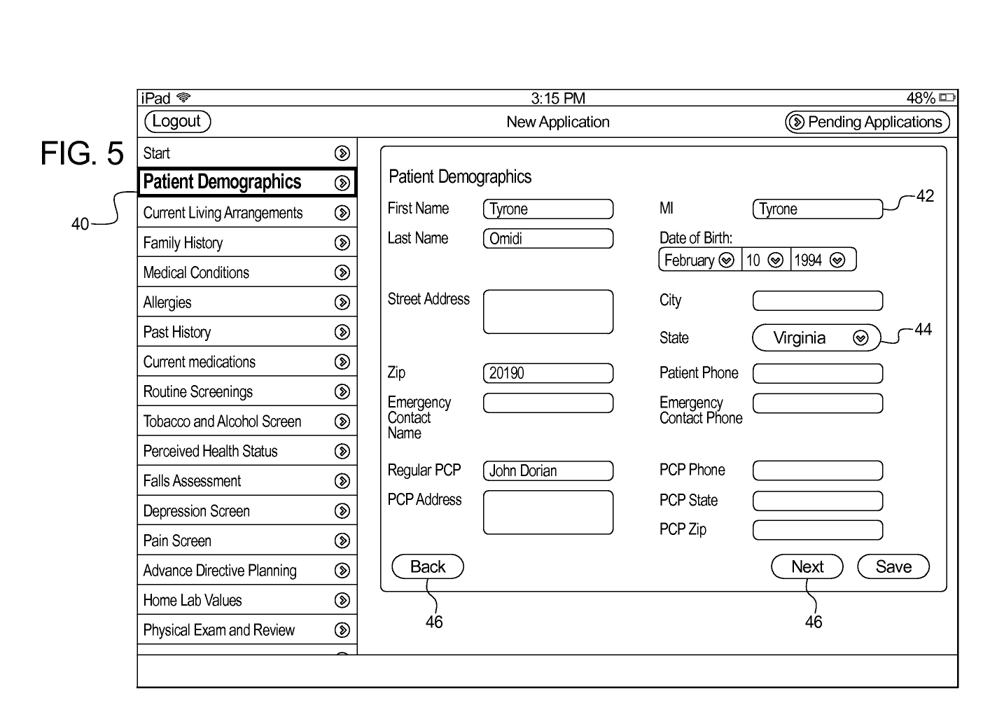

Once a pending application is selected, the user 18 is taken to the main menu 40 shown in FIG. 5. In the example shown in FIG. 5, the navigation for the main menu 40 is provided along on the left-hand side of the screen and includes links to pages for collecting information relating to patient demographic and personal information, current living arrangements, family history, medical conditions, allergies, past history, current medications, routine screenings, tobacco and alcohol screen, perceived health status, fails assessment, depression screen, pain screen, advance directive planning, home lab values, physical exam and review, and other selections not shown. It will be recognized by those skilled in the art that in other embodiments of the application the main menu 40 may either include a greater or lesser number of selections. Once a selection from the main menu 40 is made, that associated page appears on the right of the screen. In the example shown in FIG. 5, the patient demographics screen is selected, and shown on the right.

The patient demographics screen shown in FIG. 5 includes several entry fields 42 such as name, date of birth, address, phone number, emergency contact, and personal care provider information. However, it is contemplated that in other embodiments other fields may exist. Information may be entered using entry fields 42, where the user 18 may enter all of the information, such as their name, address, and other contact information. There may also be selection fields 44 including a drop down menu or other data entry mechanism. For example, in FIG. 5, the customer's date of birth and state of residency may be entered using a drop down menu.

Each screen may include a navigation button 46 allowing the user 18 to navigate through the various screens in the application. In the example shown in FIG. 5, the navigation buttons 46 include a back button, a next button, and a save button. If the user 18 chooses the next button, they may be directed to the next screen as shown on the main menu 40 on the left hand side of the screen. For example, if the user 18 was on the patient demographic page, and then selected the next button, they would then be brought to the current living arrangements page, which is the next screen shown below the patient demographics page on the main menu 40. However, it is contemplated that the navigation buttons 46 may include different buttons, menus, sections, etc. as will be recognized by those skilled in the art.

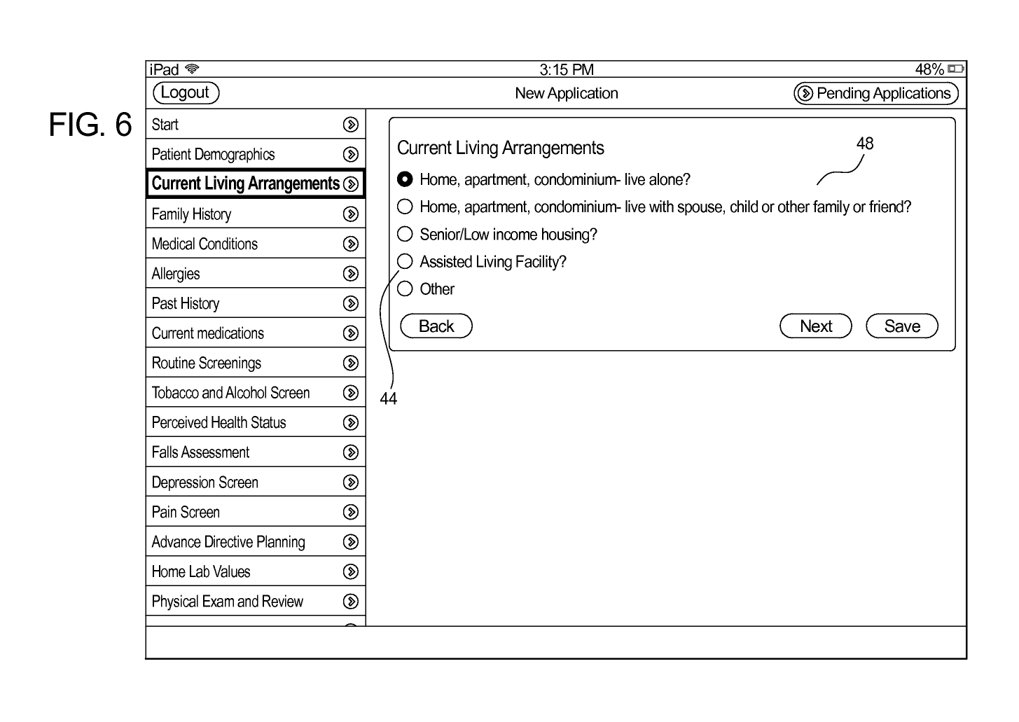

Turning now to the current living arrangements page as shown in FIG. 6, the user 18 may mark selection fields 44 out of the suggested fields 48. In the example shown in FIG. 6, there are five suggested fields 48 on the current living arrangements page, where the user 18 may select one depending on where the customer lives. In this example, since a customer may only live in one place, only one selection may be made. However, in other examples, multiple fields may be selected.

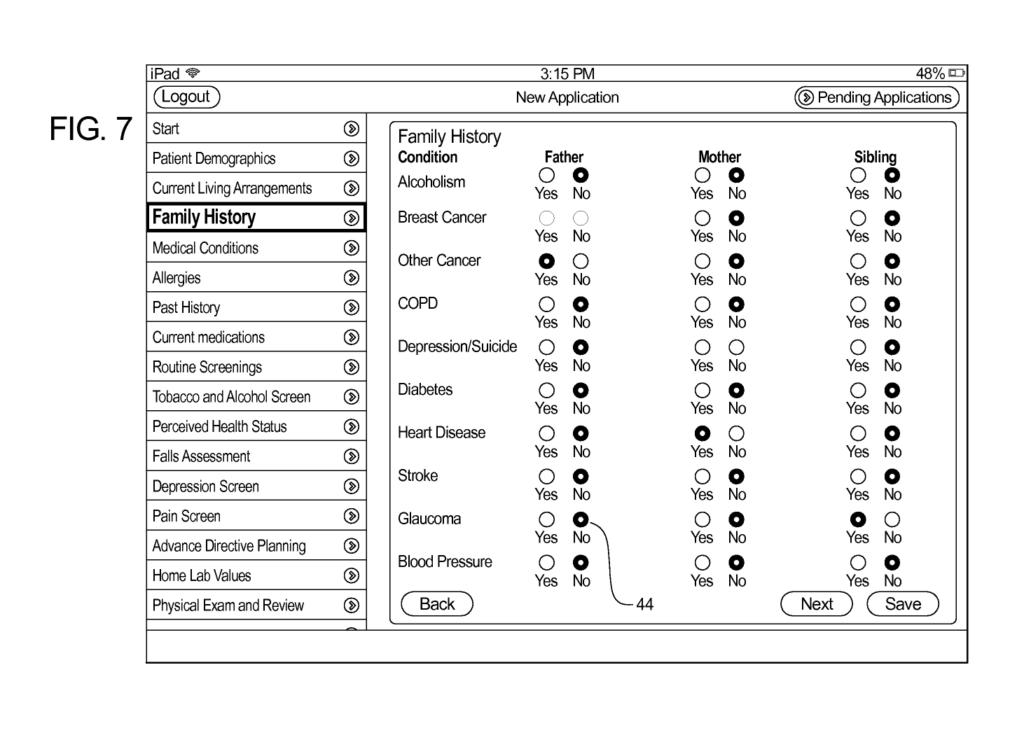

FIG. 7 illustrates an example of a form in which a family history page may be provided. On this screen, there are multiple selection fields 44 that must be marked as either yes or no. In this instance, the fields may all initially be marked no by default, such that the user 18 may not have to manually go through and mark every field, since it is not likely that a customer will have had family members with all the listed kinds of conditions. This will save time, and allow the user 18 to only change the appropriate fields from no to yes. It is also contemplated that there may be a button that may be selected to mark all of the selection fields 44 no once the user comes to the page. This alternative may ensure that the screen is not routinely passed over, but requires an active selection made by the user 18. That way, even if the customer does not have any family with any of the listed conditions, the user 18 must still have to actively choose to mark all of the selection fields 44 as no.

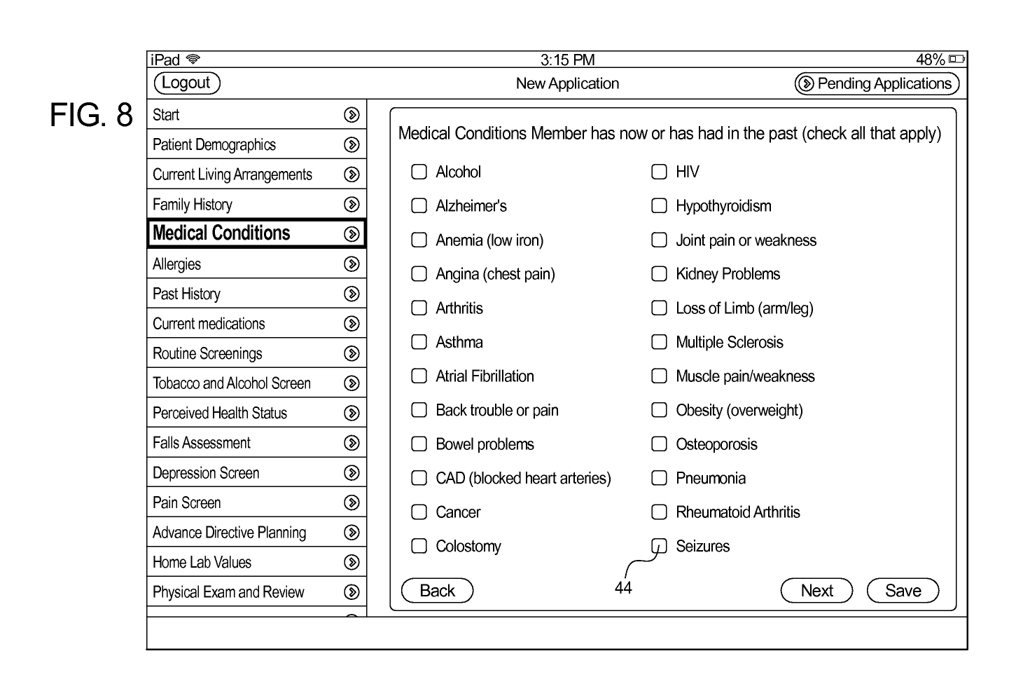

Turning now to FIG. 8, the medical conditions screen is selected, listing a wide variety of possible medical conditions from which the customer may be affected. In the example shown, the user 18 need only select the selection fields 44 for the conditions from which the customer is affected. However, it is contemplated that in other embodiments, the medical conditions screen may be formatted in a yes or no selection pattern, as shown in FIG. 7, ensuring that the screen and the selections within the screen are not overlooked.

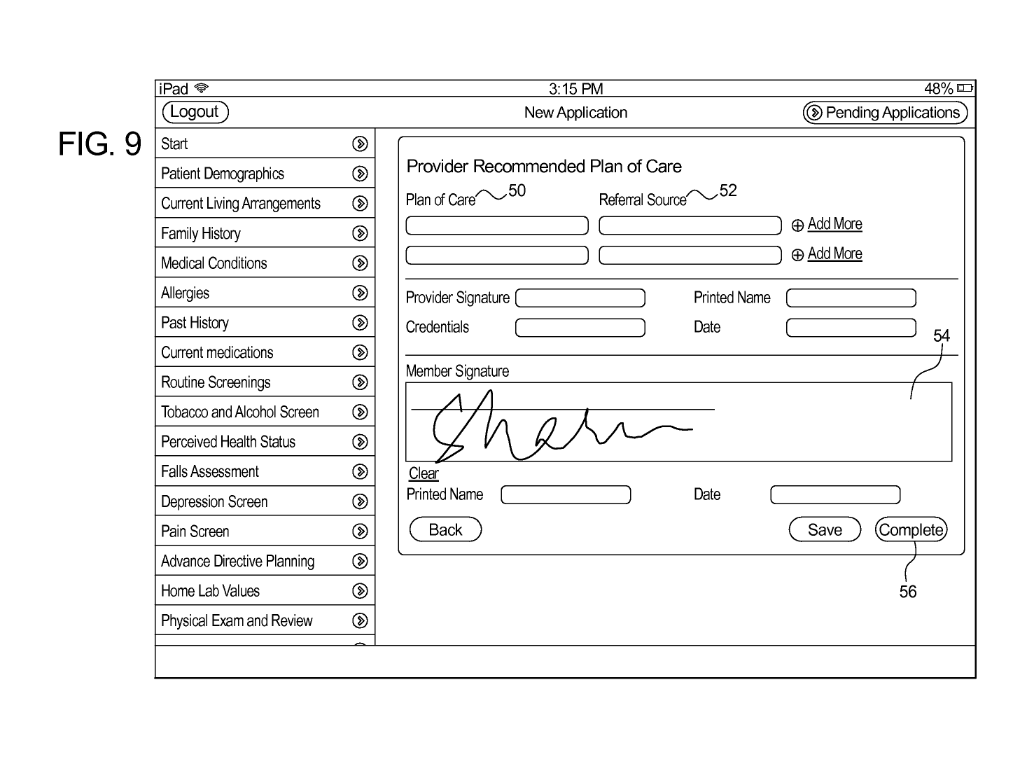

After all of the screens provided on the main menu 40 have been completed, the user 18 may be brought to the provider recommended plan of care screen 50 shown in FIG. 9. As described above, the medical screening system 10 may generate a suggested plan of care based on the information collected through the medical screening system 10. The plan of care screen 50 may also include a referral source 52 to support the recommended plan of care. As shown, there may also be fields for a provider signature and other data (e.g., printed name, credentials, date). After the plan of care 50 is available and presented to the customer, the customer may sign in the signature blank 54. After the customer provides an acceptable signature, the customer may enter his or her name and date in the entry fields 42 below the signature blank 54.

Once the application is complete, the user 18 may select a completion button 56 located beside the navigation buttons 46. Selecting the completion button 56 may close the current application saving the data within the mobile device 12.

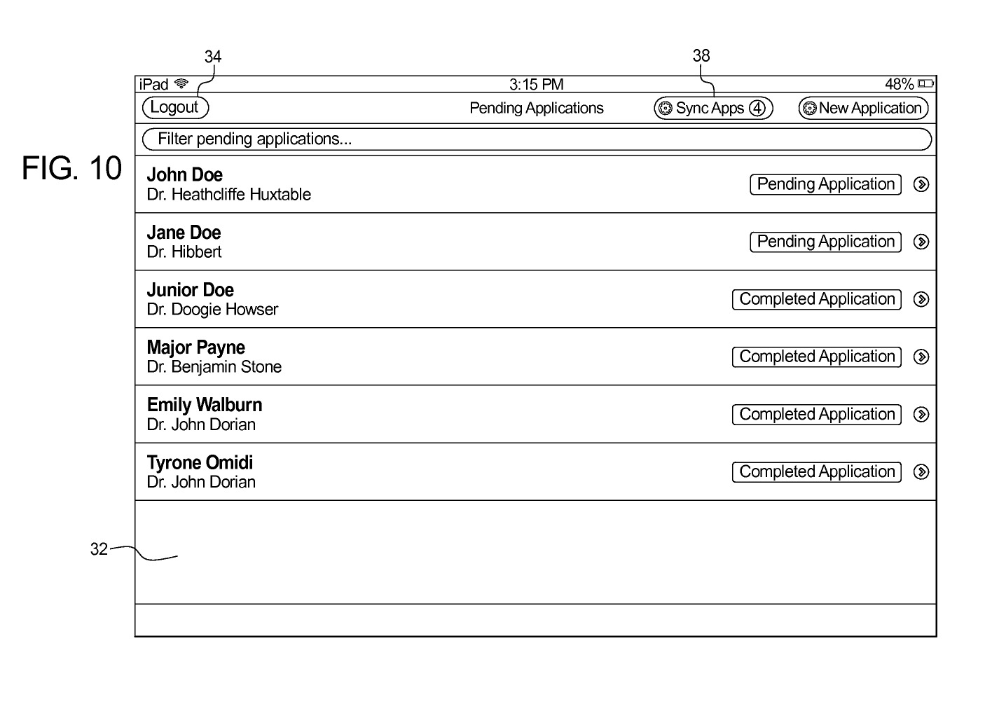

Turning now to FIG. 10, after completion, the applications screen 32 lists this application as a completed application rather than a pending application. Once the application is completed, the sync button 38 may be selected to sync the completed application to the server 14. When the completed application is synced to the server 14, it will be available to be accessed by a second user 20 (or any number of additional users) that may access and use the collected information in any manner in furtherance of their business. For example, the second user 20 may access the information to review or establish one or more risk scores, as described above. The medical insurance provider can then use the data collected and the test results to determine what additional services the customer may or may not need to improve their health status based on the individual's risk profile. In alternative embodiments, the risk score may be used to determine whether the customer is appropriate/desired for medical coverage and at what price tier. The second user 20 may be an associate of an insurance company, accountable care organization, or any other party that may need access to the customer's information.

The medical screening system 10 may be further utilized to perform a post-hospital follow-up medical screening to assess the risk of readmission of a customer. In an embodiment, the medical screening involves questioning the patient in various risk areas such as, for example: (1) utilization; (2) chronic conditions; (3) medication; (4) therapy management; (5) depression; (6) activities of daily living; and (7) malnutrition. Based on the customer's responses, the customer may be classified into risk categories for each risk area. For example, the patient may be classified as a high-risk, a medium-risk, or a low-risk in each category. The risk categories may be aggregated into an overall risk of readmission that may likewise be characterized as one of a high risk, medium risk, or low risk of readmission. Accordingly, the medical screening system 10 may be used to predict the likelihood of the customer requiring readmission to the hospital, which may be used by the insurer or the accountable care organization to manage the post-hospital care of the customer. Examples of the risk areas are provided below.

In one embodiment, utilization risk is a measure of the use of medical services over a recent period of time or known risk factors strongly correlated with use of medical services. For example, a high-risk classification may be assigned to customers that have: (i) poor social support; (ii) are eighty years or older; and (iii) have experienced two or more hospitalizations or emergency department visits in the past month. Likewise, a moderate-risk classification may be applied to any customer having two or more emergency department visits in the last six months, without the other high-risk factors. A low-risk classification may be applied to customers with fewer than two emergency department visits in the last two months. In other embodiments, other indicators, scales or threshold levels may be used, as will be appreciated by those skilled in the art from the examples provided.

An example of determining chronic condition risk involves measuring the number of chronic conditions experienced by the customer. In an embodiment, the customer is questioned to determine the number of high-risk chronic conditions and the total number of chronic conditions. A high-risk classification may be applied to customers having six or more chronic conditions including two or more of the following chronic conditions: chronic heart failure (CHF), diabetes mellitus (DM), peripheral vascular disease (PVD), chronic obstructive pulmonary disease (COPD), and depression. A medium-risk classification may applied to customers having four or more chronic conditions including at least one chronic condition in the following list: CHF, DM, PVD, chronic paid, and depression. A low-risk classification may be applied to customers having no high-risk chronic conditions and fewer than four total chronic conditions. In other embodiments, other indicators, scales or threshold levels may be used, as will be appreciated by those skilled in the art from the examples provided.

In an example, determining the medication therapy management risk involves quantifying the amount of medication prescribed to the customer as well as the customer's adherence to the prescription regimen. A customer may be classified based on the number of unique prescription medications as well as the customer's answers to a health risk assessment questionnaire regarding adherence to their prescription instructions. For example, a high-risk classification may be applied to a customer having ten or more unique prescription medications in the past six months and/or answering any health risk assessment question in a way suggesting suboptimal adherence. A moderate-risk classification may be applied to any customer having eight or more unique prescription medications in the past six months and/or indicating a difficulty affording the prescription medications. A low-risk classification may be applied to any customer having fewer than eight unique prescription medications in the last six months. In other embodiments, other indicators, scales or threshold levels may be used, as will be appreciated by those skilled in the art from the examples provided.

In an example, the depression risk assessment involves quantifying the psychiatric health of the customer. A customer may be scored on a validated depression score scale such as PHQ-9. For example, a high-risk classification may be applied to customers scoring a 15 or greater on the PHQ-9 scale, a moderate-risk classification may be applied to customers scoring between 10 and 14, and a low-risk classification may be applied to scores of less than 10. In other embodiments, other indicators, scales or threshold levels may be used, as will be appreciated by those skilled in the art from the examples provided.

An example of an “activities of daily living risk assessment” involves quantifying the ability of a customer to perform daily self-care activities, such as dressing/bathing, eating, ambulating (walking), toileting, and hygiene. A customer may be scored on an “independent activities of daily living” scale such as the Disability Accumulation Index. For example, a high-risk categorization may be applied when a customer receives a score of 36 or more on the Disability Accumulation Index, a moderate-risk categorization may be applied to customers having difficulties with any of the activities, and a low-risk categorization may be applied to any customer fully able to perform the activities. In other embodiments, other indicators, scales or threshold levels may be used, as will be appreciated by those skilled in the art from the examples provided.

In an example, the malnutrition assessment involves quantifying the diet and nutrition of the customer. A customer may be scored based on the customer's weight and/or body mass index (BMI). For example, a customer may be classified as high risk if the customer has a BMI at or below 18.5 and/or unexplained weight loss, and a low risk if BMI is above 18.5. In other embodiments, other indicators, scales or threshold levels may be used, as will be appreciated by those skilled in the art from the examples provided.

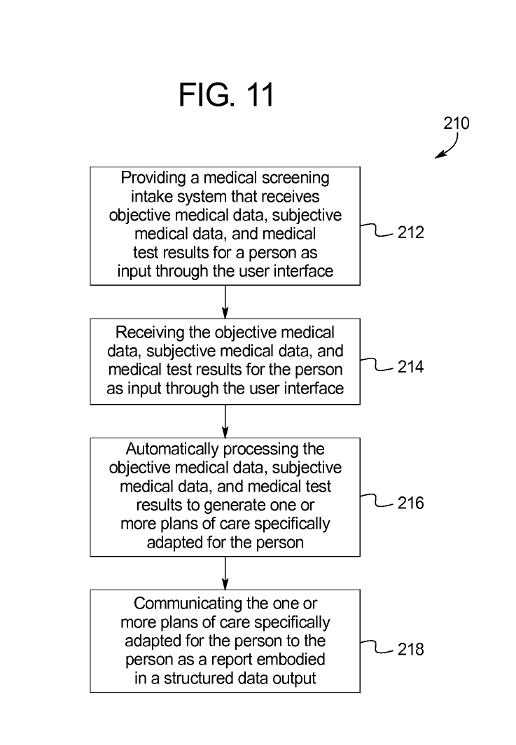

The medical screening system 10 may be used to generate one or more plans of care specifically adapted for the customers and communicate the one or more plans of care to the customers as a report embodied in a structured data output. The structured data output may identify: the customer; the objective medical data, subjective medical data, and/or medical test results associated with the one or more plans of care; and the one or more plans of care. FIG. 11 illustrates one example of a medical screening system 10 used to generate one or more plans of care specifically adapted for the customers and communicate the one or more plans of care to the customers as a report embodied in a structured data output.

As shown in FIG. 11, a medical screening system 10 may generate one or more plans of care by executing a method 210 including: providing, at step 212, a medical screening intake system that receives objective medical data, subjective medical data, and medical test results for a person as input through the user interface; receiving, at step 214, the objective medical data, subjective medical data, and medical test results for the person as input through the user interface; automatically processing, at step 216, the objective medical data, subjective medical data, and medical test results to generate one or more plans of care specifically adapted for the person; and communicating, at step 218, the one or more plans of care specifically adapted for the person to the person as a report embodied in a structured data output.

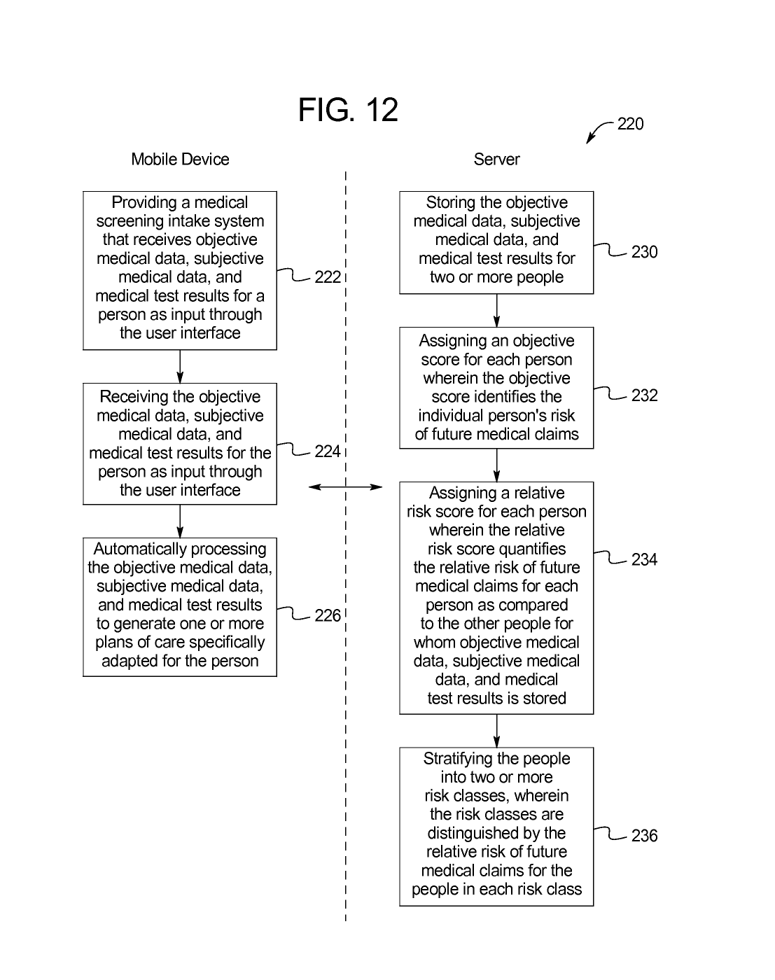

The medical screening system 10 may be used to automatically stratify the people for whom objective medical data, subjective medical data, and medical test results is stored into two or more risk classes, wherein the risk classes are distinguished by the relative risk of future medical claims for the people in each risk class. FIG. 12 illustrates one example of a medical screening system 10 used to automatically stratify the people for whom objective medical data, subjective medical data, and medical test results is stored into two or more risk classes, wherein the risk classes are distinguished by the relative risk of future medical claims for the people in each risk class.

As shown in FIG. 12, the medical screening system 10 may execute a method 220 to automatically stratify the people into two or more risk classes. The mobile device 12 and the server 14 of the medical screening system 10 may communicate to carry out the steps of the method 220 and may carry out the steps in any order needed to provide the functionality.

The method 220 of FIG. 12 may include the steps executed by the mobile device 12 of: providing, at step 222, a medical screening intake system that receives objective medical data, subjective medical data, and medical test results for a person as input through the user interface; receiving, at step 224, the objective medical data, subjective medical data, and medical test results for the person as input through the user interface; and automatically processing, at step 226, the objective medical data, subjective medical data, and medical test results to generate one or more plans of care specifically adapted for the person;

The method 220 of FIG. 12 may further include the steps executed by the server 14 of: storing, at step 230, the objective medical data, subjective medical data, and medical test results for two or more people; assigning, at step 232, an objective score for each person wherein the objective score identifies the individual person's risk of future medical claims; assigning, at step 234, a relative risk score for each person wherein the relative risk score quantifies the relative risk of future medical claims for each person as compared to the other people for whom objective medical data, subjective medical data, and medical test results is stored; and stratifying, at step 236, the people into two or more risk classes, wherein the risk classes are distinguished by the relative risk of future medical claims for the people in each risk class.

Many, but not all, of the contemplated embodiments of the presently disclosed subject matter can be implemented in part using a mobile device 12, such as a smartphone. Though used as the primary embodiment described herein, a mobile device 12 is only one example of a hardware system that may be used to accomplish the solutions provided by the present disclosure. Any computing system with the relevant peripherals may be utilized to accomplish the solutions, as will be recognized by those skilled in the art.

The mobile device 12 may include a memory interface, one or more data processors, image processors and/or central processors, and a peripherals interface. The memory interface, the one or more processors and/or the peripherals interface can be separate components or can be integrated in one or more integrated circuits. The various components in the mobile device 12 can be coupled by one or more communication buses or signal lines, as will be recognized by those skilled in the art.

Sensors, devices, and additional subsystems can be coupled to the peripherals interface to facilitate various functionalities. For example, a motion sensor (e.g., a gyroscope), a light sensor, and a positioning sensor (e.g., GPS receiver) can be coupled to the peripherals interface to facilitate the orientation, lighting, and positioning functions described further herein. Other sensors can also be connected to the peripherals interface, such as a proximity sensor, a temperature sensor, a biometric sensor, or other sensing device, to facilitate related functionalities.

A camera subsystem and an optical sensor (e.g., a charged coupled device (CCD) or a complementary metal-oxide semiconductor (CMOS) optical sensor) can be utilized to facilitate camera functions, such as recording photographs and video clips.

Communication functions can be facilitated through one or more wireless communication subsystems, which can include radio frequency receivers and transmitters and/or optical (e.g., infrared) receivers and transmitters. The specific design and implementation of the communication subsystem can depend on the communication network(s) over which the mobile device 12 is intended to operate. For example, the mobile device 12 can include communication subsystems designed to operate over a GSM network, a GPRS network, an EDGE network, a Wi-Fi or WiMax network, and a Bluetooth™ network. In particular, the wireless communication subsystems may include hosting protocols such that the mobile device 12 may be configured as a base station for other wireless devices.

An audio subsystem can be coupled to a speaker and a microphone to facilitate voice-enabled functions, such as voice recognition, voice replication, digital recording, and telephony functions.

The I/O subsystem can include a touch screen controller and/or other input controller(s). The touch-screen controller can be coupled to a touch screen. The touch screen and touch screen controller can, for example, detect contact and movement, or break thereof, using any of a plurality of touch sensitivity technologies, including but not limited to capacitive, resistive, infrared, and surface acoustic wave technologies, as well as other proximity sensor arrays or other elements for determining one or more points of contact with the touch screen. The other input controller(s) can be coupled to other input/control devices, such as one or more buttons, rocker switches, thumb-wheel, infrared port, USB port, and/or a pointer device such as a stylus. The one or more buttons can include an up/down button for volume control of the speaker and/or the microphone.

The memory interface can be coupled to memory. The memory can include high-speed random access memory and/or non-volatile memory, such as one or more magnetic disk storage devices, one or more optical storage devices, and/or flash memory (e.g., NAND, NOR). The memory can store operating system instructions, such as Darwin, RTXC, LINUX, UNIX, OS X, iOS, ANDROID, WINDOWS, or an embedded operating system such as VxWorks. The operating system instructions may include instructions for handling basic system services and for performing hardware dependent tasks. In some implementations, the operating system instructions can be a kernel (e.g., UNIX kernel).

The memory may also store communication instructions to facilitate communicating with one or more additional devices, one or more computers and/or one or more servers. The memory may include graphical user interface instructions to facilitate graphic user interface processing; sensor processing instructions to facilitate sensor-related processing and functions; phone instructions to facilitate phone-related processes and functions; electronic messaging instructions to facilitate electronic-messaging related processes and functions; web browsing instructions to facilitate web browsing-related processes and functions; media processing instructions to facilitate media processing-related processes and functions; GPS/Navigation instructions to facilitate GPS and navigation-related processes and instructions; camera instructions to facilitate camera-related processes and functions; and/or other software instructions to facilitate other processes and functions (e.g., access control management functions, etc.). The memory may also store other software instructions controlling other processes and functions of the mobile device 12 as will be recognized by those skilled in the art. In some implementations, the media processing instructions are divided into audio processing instructions and video processing instructions to facilitate audio processing-related processes and functions and video processing-related processes and functions, respectively. An activation record and International Mobile Equipment Identity (IMEI) or similar hardware identifier can also be stored in memory.

Each of the above identified instructions and applications can correspond to a set of instructions for performing one or more functions described herein. These instructions need not be implemented as separate software programs, procedures, or modules. The memory can include additional instructions or fewer instructions. Furthermore, various functions of the mobile device 12 may be implemented in hardware and/or in software, including in one or more signal processing and/or application specific integrated circuits. Accordingly, the instructions for performing one or more functions described herein may be embodied in a non-transitory computer readable medium.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A medical screening system comprising:
a mobile device including:
a user interface embodied in an input/output system;
a processor; and
a memory in communication with the processor, including stored instructions that, when executed by the processor, cause the processor to:
provide a medical screening intake system that receives objective medical data, subjective medical data, and medical test results for a person as input through the user interface;
receive the objective medical data, subjective medical data, and medical test results for the person as input through the user interface;
automatically process the objective medical data, subjective medical data, and medical test results to generate one or more plans of care specifically adapted for the person; and
communicate the one or more plans of care specifically adapted for the person to the person as a report embodied in a structured data output.

2. The medical screening system of claim 1 wherein the one or more plans of care include standard recommendations from the Centers for Disease Control and Prevention for conditions identified in the objective medical data, subjective medical data, or medical test results.

3. The medical screening system of claim 2 further including a server in communication with one or more of the mobile devices, wherein the server stores the objective medical data, subjective medical data, and medical test results for two or more people.

4. The medical screening system of claim 3 wherein an objective score is assigned for each person for whom objective medical data, subjective medical data, and medical test results is stored.

5. The medical screening system of claim 4 wherein the objective score identifies the individual person's risk of future medical claims.

6. The medical screening system of claim 4 wherein a relative risk score is assigned for each person for whom objective medical data, subjective medical data, and medical test results is stored.

7. The medical screening system of claim 6 wherein the relative risk score quantifies the relative risk of future medical claims for each person for whom objective medical data, subjective medical data, and medical test results is stored as compared to the other people for whom objective medical data, subjective medical data, and medical test results is stored.

8. The medical screening system of claim 6 wherein the system automatically stratifies the people for whom objective medical data, subjective medical data, and medical test results is stored into two or more risk classes, wherein the risk classes are distinguished by the relative risk of future medical claims for the people in each risk class.

9. A medical screening system comprising:
one or more mobile devices, each mobile device including:
a user interface embodied in an input/output system;
a processor; and
a memory in communication with the processor, including stored instructions that, when executed by the processor, cause the processor to:
provide a medical screening intake system that receives objective medical data, subjective medical data, and medical test results for a person as input through the user interface;
receive the objective medical data, subjective medical data, and medical test results for the person as input through the user interface; and
automatically process the objective medical data, subjective medical data, and medical test results to generate one or more plans of care specifically adapted for the person; and
a server in communication with one or more of the mobile devices, wherein the server stores the objective medical data, subjective medical data, and medical test results for two or more people;
wherein an objective score is assigned for each person for whom objective medical data, subjective medical data, and medical test results is stored, wherein the objective score identifies the individual person's risk of future medical claims;
wherein a relative risk score is assigned for each person for whom objective medical data, subjective medical data, and medical test results is stored, wherein the relative risk score quantifies the relative risk of future medical claims for each person for whom objective medical data, subjective medical data, and medical test results is stored as compared to the other people for whom objective medical data, subjective medical data, and medical test results is stored;
wherein the system automatically stratifies the people for whom objective medical data, subjective medical data, and medical test results is stored into two or more risk classes, wherein the risk classes are distinguished by the relative risk of future medical claims for the people in each risk class.
